(19) United States
(12) Patent Application Publication
(10) Pub. No.: US 2011/0193888 A1
(43) Pub. Date: Aug. 11, 2011

(54) IMAGE DISPLAY DEVICE

(76) Inventors: Asahi Yamato, Osaka-shi (JP); Kozo Takahashi, Osaka-shi (JP)

(21) Appl. No.: 12/998,303

(22) PCT Filed: Jun. 2, 2009
(86) PCT No.: PCT/JP2009/060026

§ 371 Date: Apr. 6, 2011

(30) Foreign Application Priority Data
Oct. 10, 2008 (JP) 2008-263851

(51) Int. Cl. G09G 3/36; G09G 5/10

(52) U.S. Cl. 345/690; 345/102

(57) ABSTRACT

An image characteristic judgement circuit analyzes input image data and obtains first brightness data indicating brightness of a backlight within a single vertical period and image characteristic data corresponding to the first brightness data. In at least one embodiment, an image data conversion circuit performs conversion to the input image data according to the image characteristic data and outputs the image data after the conversion to a liquid crystal panel. A period-by-period brightness calculation circuit obtains, based on the first brightness data, second brightness data indicating brightness of the backlight within each of a plurality of periods into which the single vertical period is divided. A brightness setting circuit 18 controls the brightness of the backlight using the second brightness data. Flickers in a screen are reduced by changing the brightness of the backlight within a single vertical period in this manner.

### TECHNICAL FIELD

The present invention relates to an image display device provided with a backlight, such as a liquid crystal display device.

### BACKGROUND ART

For image display devices provided with a backlight, such as liquid crystal display devices, there is known a technology for reducing power consumption of the backlight by controlling brightness of the backlight according to characteristics of an image to be displayed (active backlight technology). For example, brightness of a screen of a liquid crystal display device is determined based on a product of brightness of a backlight and transmittance of liquid crystals. Therefore, when a maximum value of the brightness of the display screen is 50% of the maximum brightness, the brightness of the backlight is controlled to be half, and the transmittance of the liquid crystals to be twice. With this, it is possible to reduce the brightness of the backlight by half while displaying the screen in correct brightness, and to reduce power consumption of the backlight to a large extent.

Regarding the active backlight technology, various methods are conventionally known. For example, Patent Document 1 describes detecting a temperature near a liquid crystal panel, and adjusting timing backward or forward to change brightness of a backlight according to the detected temperature.

### RELATED DOCUMENT

### Patent Document

[Patent Document 1] Japanese Laid-Open Patent Publication No. 2003-255914

### SUMMARY OF THE INVENTION

### Problems to be Solved by the Invention

A typical image display device using active backlight technology has a problem that flickers occur in a screen. FIG. 8 is a diagram showing an example of a display screen of a liquid crystal display device. In the display screen shown in FIG. 8, it is assumed that, during a time period in which brightness of a region A (left half) is 50% of a maximum brightness, brightness of a region B (right half) changes from 100% to 60% of the maximum brightness. When controlling brightness of a backlight according to the maximum brightness of the display screen, the brightness of the backlight changes from 100% to 60% of the maximum brightness along with a change in the brightness of the region B.

In order to keep a level of the brightness of the region A to be the same as the previous level even if the brightness of the backlight changes, it is sufficient to increase a voltage applied to liquid crystals in the region A, and to make transmittance of the liquid crystals in the region A to be 100/60=5/3 times. However, while the brightness of the backlight changes in a short period of time, the transmittance of the liquid crystals does not change immediately after the applied voltage is changed. Accordingly, even though the brightness of the screen that is determined based on a product of the brightness of the backlight and the transmittance of the liquid crystals should be constant within a single vertical period (1 frame period) under normal conditions, it changes within a single vertical period actually.

FIG. 9 is a chart showing a change in the brightness of a screen in the conventional liquid crystal display device using the active backlight technology. FIG. 9 shows brightness of a portion whose brightness of the display screen does not change (e.g., the region A in FIG. 8) when a maximum brightness of the display screen decreases and the brightness of the backlight also decreases along with this. In order to keep a level of the brightness of the screen constant, it is necessary to increase transmittance of liquid crystals correspondingly to the decrease of the brightness of the backlight. However, as the transmittance of the liquid crystals changes slowly and the brightness of the screen also changes slowly, the brightness of the screen changes to a large extent within a single vertical period. Accordingly, a viewer sees the screen flickering.

Further, according to the conventional liquid crystal display device, the brightness of the backlight changes only once in a single vertical period. Accordingly, when the brightness of the backlight changes to a large extent, a viewer sees the screen flickering at this moment. Such flickers cannot be suppressed even with adjustment of timing backward or forward to change the brightness of the backlight as described in Patent Document 1.

Thus, an object of the present invention is to reduce flickers in a screen for an image display device that controls brightness of a backlight.

### Means for Solving the Problems

According to a first aspect of the present invention, there is provided an image display device that controls brightness of a backlight, the device including: a display panel; a backlight that irradiates a back surface of the display panel with light; an image characteristic judgement portion that analyzes input image data and obtains first brightness data indicating brightness of the backlight within a single vertical period and image characteristic data corresponding to the first brightness data; an image data converting portion that performs conversion to the input image data according to the image characteristic data and outputs the image data after the conversion to the display panel; a period-by-period brightness calculating portion that obtains, based on the first brightness data, second brightness data indicating brightness of the backlight within each of a plurality of periods into which the single vertical period is divided; and a brightness setting portion that controls the brightness of the backlight using the second brightness data.

According to a second aspect of the present invention, in the first aspect of the present invention, the period-by-period brightness calculating portion obtains, as the second brightness data, data indicating brightness that changes in a stepwise manner from previous brightness to current brightness within a single vertical period based on the previous brightness and the current brightness, the previous brightness being indicated by first brightness data based on input image data of a previous frame, the current brightness being indicated by first brightness data based on input image data of a current frame.

According to a third aspect of the present invention, in the second aspect of the present invention, the period-by-period brightness calculating portion obtains, as the second brightness data, data indicating brightness that has been linearly-interpolated between the previous brightness and the current brightness, based on the previous brightness and the current brightness.

According to a fourth aspect of the present invention, in the second aspect of the present invention, the period-by-period brightness calculating portion obtains, as the second brightness data, data indicating brightness whose amount of change decreases in a stepwise manner from a former period to a latter period, based on the previous brightness and the current brightness.

According to a fifth aspect of the present invention, in the second aspect of the present invention, the period-by-period brightness calculating portion divides a single vertical period into periods of different lengths and obtains the second brightness data.

According to a sixth aspect of the present invention, in the fifth aspect of the present invention, the period-by-period brightness calculating portion divides a single vertical period such that the lengths of the periods increase in a stepwise manner from a former period to a latter period.

According to a seventh aspect of the present invention, in the first aspect of the present invention, the period-by-period brightness calculating portion includes: a brightness calculating portion that obtains the brightness of the backlight of each of the plurality of periods into which the single vertical period is divided, based on the brightness indicated by the first brightness data; and a brightness conversion portion that converts the brightness obtained by the brightness calculating portion into a format outputtable to the brightness setting portion.

According to an eighth aspect of the present invention, in the first aspect of the present invention, the period-by-period brightness calculating portion includes: a brightness conversion portion that converts the brightness indicated by the first brightness data into a format outputtable to the brightness setting portion; and a brightness calculating portion that obtains the brightness of the backlight of each of the plurality of periods into which the single vertical period is divided in the format outputtable to the brightness setting portion, based on the brightness converted by the brightness conversion portion.

According to a ninth aspect of the present invention, in the first aspect of the present invention, the period-by-period brightness calculating portion obtains, as the second brightness data, data indicating brightness that changes in steps of a greater number than the brightness indicated by the first brightness data.

According to a tenth aspect of the present invention, there is provided a method of displaying an image in an image display device including a display panel and a backlight that irradiates a back surface of the display panel with light, the method including: a step of analyzing input image data and obtaining first brightness data indicating brightness of the backlight within a single vertical period and image characteristic data corresponding to the first brightness data; a step of performing conversion to the input image data according to the image characteristic data and outputting the image data after the conversion to the display panel; a step of obtaining, based on the first brightness data, second brightness data indicating brightness of the backlight within each of a plurality of periods into which the single vertical period is divided; and a step of controlling the brightness of the backlight using the second brightness data.

### Effects of the Invention

According to the first or tenth aspect of the present invention, it is possible to obtain the brightness of the backlight within a single vertical period according to the characteristics of the input image data, and to change the brightness of the backlight within the single vertical period based on the obtained brightness. Therefore, even if the brightness of the display panel changes slowly and the brightness of the screen changes slowly, it is possible to reduce flickers in the screen by decreasing the amount of change in the brightness of the screen within a single vertical period. Further, as the amount of change in the brightness of the backlight for each time also decreases, it is also possible to reduce the flickers in the screen that occur at the moment when the brightness of the backlight changes.

According to the second aspect of the present invention, by changing the brightness of the backlight in a stepwise manner from the previous brightness to the current brightness within a single vertical period, it is possible to reduce the flickers in the screen while controlling the brightness of the backlight to a level corresponding to the characteristics of the input image data.

According to the third aspect of the present invention, by linearly changing the brightness of the backlight from the previous brightness to the current brightness within a single vertical period, it is possible to obtain the brightness of the backlight within a single vertical period by simple arithmetic and to reduce the flickers in the screen.

According to the fourth aspect of the present invention, by decreasing the amount of change in the brightness of the backlight in a stepwise manner from the previous brightness to the current brightness within a single vertical period, it is possible to effectively reduce the flickers in the screen when the amount of change in the brightness of the display panel varies within a single vertical period.

According to the fifth aspect of the present invention, by dividing a single vertical period into the periods of different lengths and obtaining the second brightness data, it is possible to effectively reduce the flickers in the screen when the amount of change in the brightness of the display panel varies within a single vertical period.

According to the sixth aspect of the present invention, by dividing a single vertical period such that the lengths of the periods increase in a stepwise manner from the former period to the latter period, it is possible to effectively reduce the flickers in the screen when the amount of change in the brightness of the display panel is large in the former period, and small in the latter period.

According to the seventh aspect of the present invention, it is possible to obtain the second brightness data by obtaining the brightness of the backlight of each of the plurality of periods into which the single vertical period is divided, based on the first brightness data, and by converting the obtained brightness into the format outputtable to the brightness setting portion.

According to the eighth aspect of the present invention, it is possible to obtain the second brightness data by converting the first brightness data into the format outputtable to the brightness setting portion, and obtaining the brightness of the backlight of each of the plurality of periods into which the single vertical period is divided in the format outputtable to the brightness setting portion, based on the brightness after the conversion.

According to the ninth aspect of the present invention, by changing the brightness of the backlight in steps of the greater number than the brightness obtained by the image characteristic judgement portion, it is possible to further reduce the flickers in the screen that occur at the moment at which the brightness of the backlight changes.

### BRIEF DESCRIPTION OF THE DRAWINGS

FIG. 1 is a block diagram showing a structure of a liquid crystal display device according to an embodiment of the present invention.

FIG. 2 is a block diagram showing a structure of a period-by-period brightness calculation circuit of the liquid crystal display device shown in FIG. 1.

FIG. 3 is a timing chart showing an operation of the liquid crystal display device shown in FIG. 1.

FIG. 4 is a chart showing a change in brightness of a screen of the liquid crystal display device shown in FIG. 1.

FIG. 5 is a block diagram showing a structure of a period-by-period brightness calculation circuit of a liquid crystal display device according to a modified example of the embodiment of the present invention.

FIG. 6 is a chart showing a change in brightness of a screen of a liquid crystal display device according to a modified example of the embodiment of the present invention.

FIG. 7 is a chart showing a change in brightness of a screen of a liquid crystal display device according to a modified example of the embodiment of the present invention.

FIG. 8 is a diagram showing an example of the display screen of the liquid crystal display device.

FIG. 9 is a chart showing a change in brightness of a screen of the conventional liquid crystal display device.

### MODE FOR CARRYING OUT THE INVENTION

FIG. 1 is a block diagram showing a structure of a liquid crystal display device according to an embodiment of the present invention. A liquid crystal display device 10 shown in FIG. 1 is provided with a liquid crystal panel 11, a backlight 12, an image characteristic judgement circuit 13, an image data conversion circuit 14, a timing adjusting circuit 15, a frequency dividing circuit 16, a period-by-period brightness calculation circuit 17, and a brightness setting circuit 18. Among these, the timing adjusting circuit 15, the frequency dividing circuit 16, the period-by-period brightness calculation circuit 17, and the brightness setting circuit 18 constitute a backlight control circuit.

The liquid crystal display device 10 obtains brightness of the backlight 12 within a single vertical period according to characteristics of an image to be displayed, and changes the brightness of the backlight 12 within the single vertical period based on the obtained brightness. Hereinafter, in the liquid crystal display device 10, it is assumed that a single vertical period is divided into M periods (M is an integer equal to or greater than 2), and the M periods are respectively referred to as a first period, a second period, . . . , and an M-th period in chronological ascending order.

In FIG. 1, the liquid crystal panel 11 includes a plurality of liquid crystal display elements (not shown) that are two-dimensionally arranged. The liquid crystal panel 11 is driven by a driving circuit (not shown), and displays a screen according to display image data.

The backlight 12 is provided on a back surface of the liquid crystal panel 11, and irradiates the back surface of the liquid crystal panel 11 with light. A structure of the backlight 12 (such as a type and a number of a light source) can be arbitrarily selected. The backlight 12 is configured by, for example, a plurality of LEDs that are one-dimensionality arranged along one side surface of a light guiding plate. The backlight 12 is driven by a backlight driving circuit (not shown), and emits light of brightness that is set by the brightness setting circuit 18.

The image characteristic judgement circuit 13 analyzes input image data and obtains first brightness data and image characteristic data based on an analysis result. The first brightness data is data representing the brightness of the backlight 12 within a single vertical period. The image characteristic data is data corresponding to the first brightness data and representing characteristics of conversion performed to the input image data. The first brightness data and the image characteristic data are obtained for each single vertical period. Further, the image characteristic judgement circuit 13 outputs a vertical synchronizing signal VSYNC indicating timing for outputting an image, and a horizontal synchronizing signal HSYNC indicating timing for outputting each line of the image.

The image characteristic judgement circuit 13, for example, generates a histogram of the input image data for a single frame, calculates various statistics (e.g., such as a maximum value and an average value) from the generated histogram, and obtains the first brightness data and the image characteristic data based on the calculated statistics. A method of obtaining the first brightness data and the image characteristic data can be arbitrarily selected. The simplest method is to determine the brightness of the backlight according to a maximum brightness within a display screen, and to determine characteristics of conversion performed to the input image data so as to compensate a change of the brightness of the backlight. The image characteristic judgement circuit 13 using this method outputs, when, for example, a maximum value of gradation included in the input image data for a single frame is 50% of maximum gradation, the first brightness data indicating that the brightness of the backlight 12 is set to be 50% of maximum brightness and image characteristic data indicating that the input image data is set to be twice. Examples of the method of determining the brightness of the backlight 12 include, in addition to this method, a method based on an average value within the display screen, and a method considering statistics that has been calculated previous time.

The image data conversion circuit 14 performs conversion, to the input image data, based on the image characteristic data obtained by the image characteristic judgement circuit 13. The image data conversion circuit 14 increases the input image data twice, for example, based on the image characteristic data. The image data conversion circuit 14 outputs the image data after the conversion as the display image data to the liquid crystal panel 11.

The timing adjusting circuit 15 is a circuit for adjusting timing to change the brightness of the backlight 12. More specifically, the timing adjusting circuit 15 moves the vertical synchronizing signal VSYNC outputted from the image characteristic judgement circuit 13 backward or forward by a predetermined time period, and outputs the moved vertical synchronizing signal VSYNC as a timing control signal TC1. Transmittance of liquid crystals included in the liquid crystal panel 11 does not change immediately after a voltage applied to the liquid crystals is changed. Accordingly, in order to display an image in an appropriate manner in the liquid crystal display device using active backlight technology, it is necessary to provide an appropriate time difference between timing to switch the voltage applied to the liquid crystals and timing to change the brightness of the backlight. According to the liquid crystal display device 10 provided with the timing adjusting circuit 15, providing an appropriate time difference between the above two types of timing allows to display an image in an appropriate manner.

The frequency dividing circuit 16 is a circuit for determining timing to start the first period to the M-th period. More specifically, the frequency dividing circuit 16 outputs, as a timing control signal TC2, a signal whose frequency is M times greater than a frequency of the horizontal synchronizing signal HSYNC outputted from the image characteristic judgement circuit 13.

To the period-by-period brightness calculation circuit 17, the first brightness data outputted from the image characteristic judgement circuit 13, the timing control signal TC1 outputted from the timing adjusting circuit 15, and the timing control signal TC2 outputted from the frequency dividing circuit 16 are inputted. The period-by-period brightness calculation circuit 17 obtains second brightness data indicating the brightness of the backlight 12 within the first period to the M-th period based on the first brightness data, in order to change the brightness of the backlight 12 in a stepwise manner within a single vertical period.

The period-by-period brightness calculation circuit 17 stores brightness indicated by first brightness data based on input image data of a previous frame (hereinafter referred to as previous brightness). When first brightness data based on input image data of a current frame is inputted, the period-by-period brightness calculation circuit 17 obtains brightness indicated by this first brightness data (hereinafter referred to as current brightness), and obtains brightness that changes in a stepwise manner from the previous brightness to the current brightness within a single vertical period as the brightness of the backlight 12 within the first period to the M-th period.

A method of obtaining the brightness of the backlight 12 within the first period to the M-th period can be arbitrarily selected. For example, the period-by-period brightness calculation circuit 17 may obtain brightness that has been linearly interpolated between the previous brightness and the current brightness as the brightness of the backlight 12 within the first period to the M-th period. In this case, where the previous brightness is Xp, and the current brightness is Xc, brightness Xi of the backlight 12 within an i-th period (i is an integer equal to or greater than 1 and equal to or smaller than M) can be derived by an equation (1) as follows.

Xi={(M−i)×Xp+i×Xc}/M (1)

At this time, the period-by-period brightness calculation circuit 17 may obtain brightness that changes in steps of a greater number than the brightness indicated by the first brightness data as the brightness of the backlight 12 within the first period to the M-th period. For example, the period-by-period brightness calculation circuit 17 may obtain 16-bit second brightness data based on 8-bit first brightness data.

The brightness setting circuit 18 controls the brightness of the backlight 12 by generating a backlight control signal according to the second brightness data outputted from the period-by-period brightness calculation circuit 17. A structure of the brightness setting circuit 18 can be arbitrarily selected. For example, when the brightness of the backlight 12 is controlled by PWM (Pulse Width Modulation), the brightness setting circuit 18 outputs, as the backlight control signal, a PWM signal that reaches a predetermined level (e.g., high level) by a ratio indicated by the second brightness data.

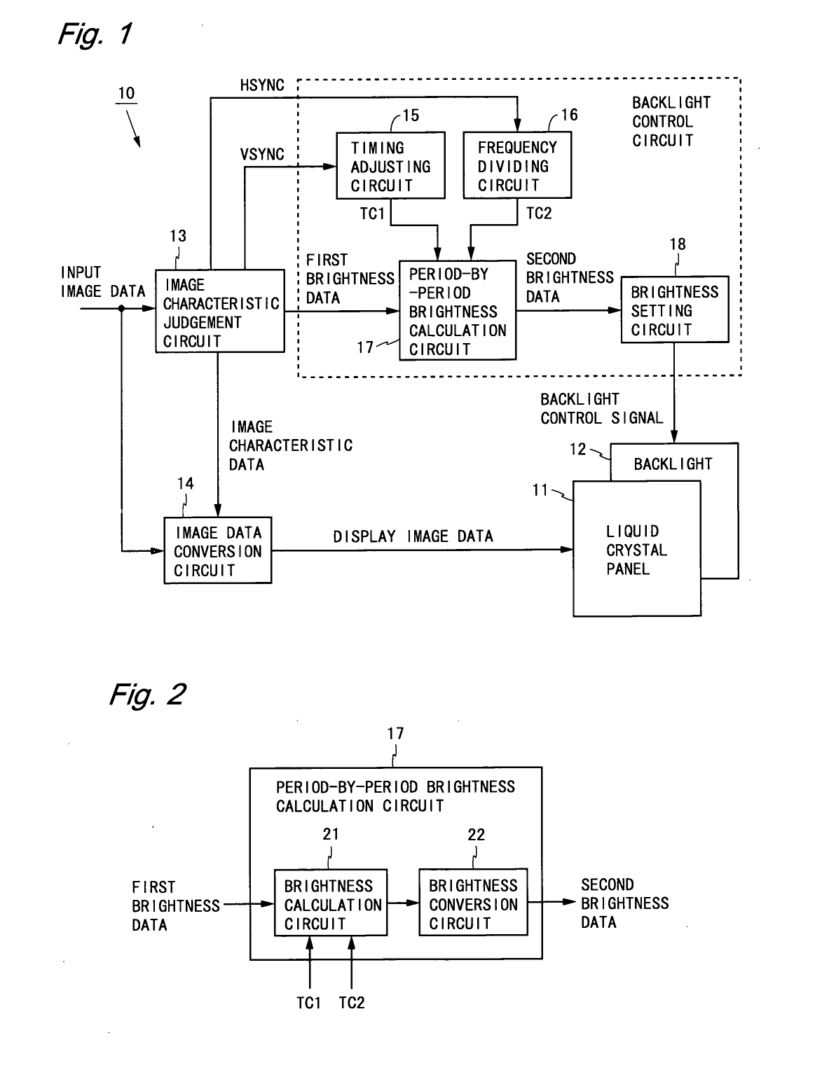

FIG. 2 is a block diagram showing a structure of the period-by-period brightness calculation circuit 17. As shown in FIG. 2, the period-by-period brightness calculation circuit 17 includes a brightness calculation circuit 21 and a brightness conversion circuit 22. The brightness calculation circuit 21 obtains the brightness of the backlight 12 within the first period to the M-th period based on the brightness indicated by first brightness data. More specifically, the brightness calculation circuit 21 stores the previous brightness, obtains the brightness of the backlight 12 within the first period to the M-th period based on the previous brightness and the current brightness, and outputs the obtained brightness according to the timing control signals TC1 and TC2. The brightness conversion circuit 22 converts the brightness obtained by the brightness calculation circuit 21 into a format outputtable to the brightness setting circuit 18, and outputs the converted brightness as the second brightness data. For example, when controlling the brightness of the backlight 12 by PWM, the brightness conversion circuit 22 converts the brightness obtained by the brightness calculation circuit 21 into a PWM value.

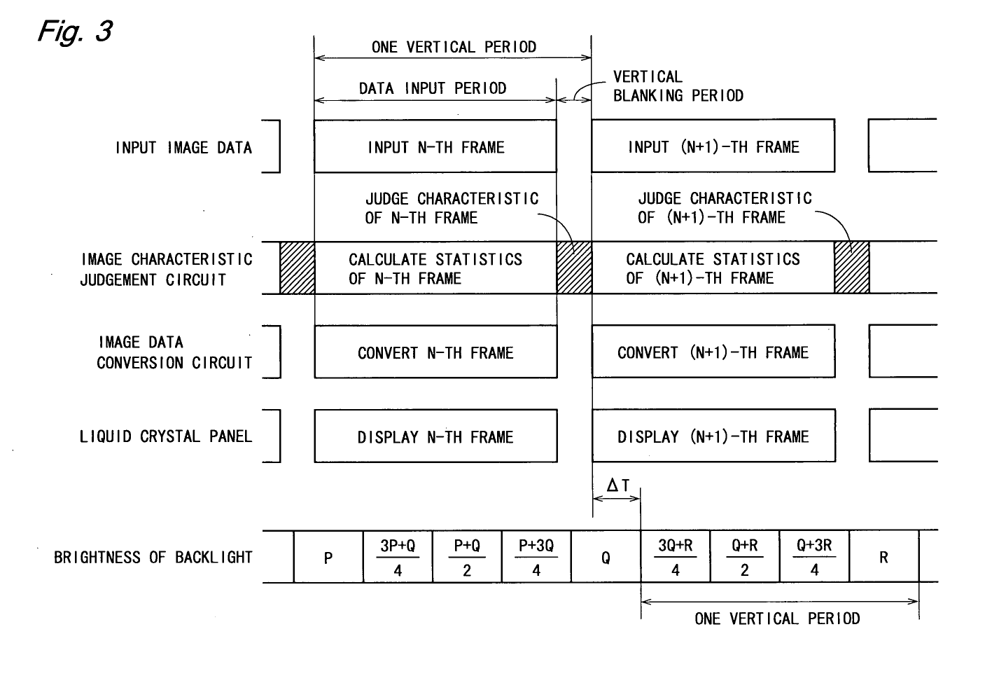

FIG. 3 is a timing chart showing an operation of the liquid crystal display device 10. As shown in FIG. 3, a single vertical period includes a data input period and a vertical blanking period. Here, it is assumed that M=4, and a single vertical period is divided into a first period to a fourth period. In the data input period of an N-th frame, image data of the N-th frame is inputted. In the data input period of the N-th frame, the image characteristic judgement circuit 13 generates a histogram for the input image data of the N-th frame, and calculates various statistics. Then, in the vertical blanking period of the N-th frame, the image characteristic judgement circuit 13 obtains the first brightness data and the image characteristic data based on the statistics calculated in the data input period of the N-th frame.

In the data input period of an (N+1)-th frame, the image data conversion circuit 14 performs conversion based on the image characteristic data obtained based on the input image data of the N-th frame to the input image data of the (N+1)-th frame. The display image data obtained by this conversion is outputted to the liquid crystal panel 11.

At an end of the vertical blanking period of the N-th frame, the period-by-period brightness calculation circuit 17 remembers brightness indicated by the first brightness data obtained in the vertical blanking period of an (N−1)-th frame (previous brightness Q). After receiving the first brightness data obtained in the vertical blanking period of the N-th frame from the image characteristic judgement circuit 13, the period-by-period brightness calculation circuit 17 obtains brightness indicated by this first brightness data (current brightness R), and obtains the brightness of the backlight 12 within the first period to the fourth period based on the previous brightness Q and the current brightness R. For example, when the brightness of the backlight 12 within the first period to the fourth period is obtained based on the equation (1), the brightness within the first period is (3Q+R)/4, the brightness within the second period is (Q+R)/2, the brightness within the third period is (Q+3R)/4, and the brightness within the fourth period is R.

The period-by-period brightness calculation circuit 17 outputs the second brightness data according to the timing control signals TC1 and TC2. Further, the timing control signal TC1 is a signal obtained by moving the vertical synchronizing signal VSYNC backward or forward by the predetermined time period. Therefore, according to the liquid crystal display device 10, a single vertical period when inputting the image data and a single vertical period when controlling the brightness of the backlight 12 are deviated by the predetermined time period. In the example shown in FIG. 3, a single vertical period when controlling the brightness of the backlight 12 is delayed by ΔT from a single vertical period when inputting the image data.

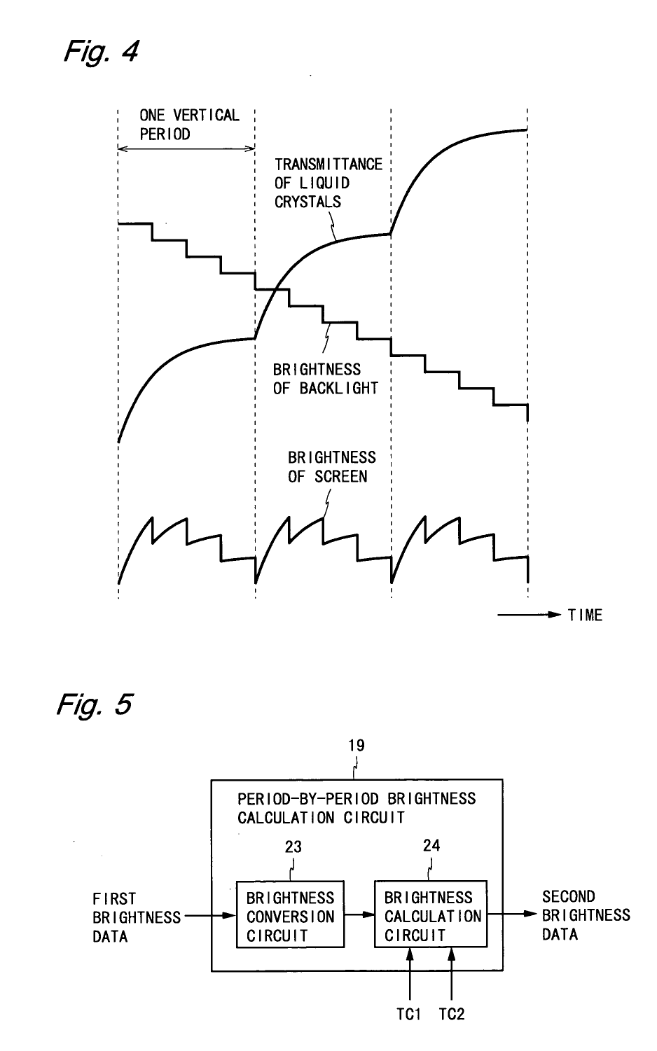

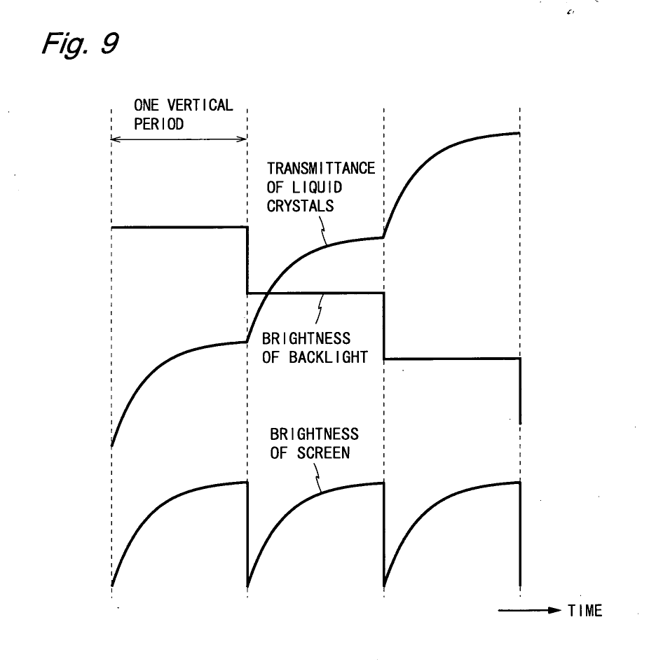

The following describes effects of the liquid crystal display device 10 according to this embodiment. FIG. 4 is a chart showing a change in brightness of a screen of the liquid crystal display device 10 according to this embodiment. Similarly to FIG. 9, FIG. 4 shows brightness of a portion whose brightness of the display screen does not change when the maximum brightness of the display screen decreases and the brightness of the backlight 12 also decreases. In order to keep a level of the brightness of the screen constant, it is necessary to increase the transmittance of the liquid crystals correspondingly to the decrease of the brightness of the backlight. A change in the transmittance of the liquid crystals shown in FIG. 4 is also the same as shown in FIG. 9.

In the liquid crystal display device 10, the brightness of the backlight 12 changes M times (four times, here) in a stepwise manner within a single vertical period. Accordingly, even if the transmittance of the liquid crystals changes slowly and the brightness of the screen also changes slowly similarly to the case of FIG. 9, an amount of change in the brightness of the screen within a single vertical period becomes smaller than the case of FIG. 9 (see FIG. 4). By decreasing the change in the brightness of the screen within a single vertical period in this manner, it is possible to reduce the flickers in the screen. Further, in the liquid crystal display device 10, the amount of change in the brightness of the backlight 12 for each time also decreases. Accordingly, it is possible to reduce the flickers in the screen that occur at the moment when the brightness of the backlight 12 changes.

Moreover, by changing the brightness of the backlight 12 in a stepwise manner from the previous brightness to the current brightness within a single vertical period, it is possible to reduce the flickers in the screen while controlling the brightness of the backlight 12 to a level corresponding to the characteristics of the input image data. In particular, by linearly changing the brightness of the backlight 12 from the previous brightness to the current brightness within a single vertical period, it is possible to obtain the brightness of the backlight within a single vertical period by simple arithmetic and to reduce the flickers in the screen.

Furthermore, by changing the brightness of the backlight 12 in steps of the greater number than the brightness obtained by the image characteristic judgement circuit 13, it is possible to further reduce the flickers in the screen. For example, if the first brightness data is 8-bit data, the brightness of the backlight 12 can be switched only in 256 steps according to the conventional liquid crystal display device. In contrast, according to the liquid crystal display device 10, by switching the brightness of the backlight 12 within the first period to the M-th period in a stepwise manner between the previous brightness and the current brightness, it is possible to control the brightness of the backlight 12 in a manner finer than the 256 steps. With this, it is possible to reduce the flickers in the screen that occur at the moment at which the brightness of the backlight 12 changes.

It should be noted that the liquid crystal display device according to this embodiment can be modified in various examples. For example, the liquid crystal display device according to the present invention may be provided with a period-by-period brightness calculation circuit 19 shown in FIG. 5 instead of the period-by-period brightness calculation circuit 17 shown in FIG. 2. The period-by-period brightness calculation circuit 19 includes a brightness conversion circuit 23 and a brightness calculation circuit 24 that are connected in an order opposite from the case of the period-by-period brightness calculation circuit 17. The brightness conversion circuit 23 converts the brightness indicated by the first brightness data into a format outputtable to the brightness setting circuit 18. The brightness calculation circuit 24 stores the previous brightness in the format outputtable to the brightness setting circuit 18. The brightness calculation circuit 24 obtains the brightness of the backlight 12 within the first period to the M-th period in the format outputtable to the brightness setting circuit 18, based on the stored brightness and the current brightness that has been converted into the format outputtable to the brightness setting circuit 18, and outputs the obtained brightness as the second brightness data.

For example, when controlling the brightness of the backlight 12 by PWM, the brightness conversion circuit 23 converts the brightness indicated by the first brightness data into a PWM value. The brightness calculation circuit stores the PWM value corresponding to the previous brightness, and obtains a PWM value corresponding to the brightness of the backlight 12 within the first period to the M-th period based on the stored PWM value and the PWM value corresponding to the current brightness. According to the liquid crystal display device provided with the period-by-period brightness calculation circuit 19, it is possible to obtain the same effect as that of the liquid crystal display device 10 provided with the period-by-period brightness calculation circuit 17.

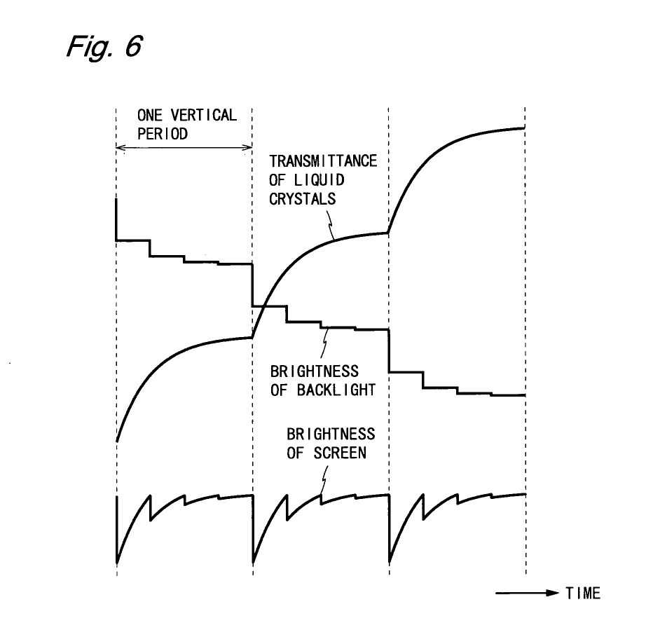

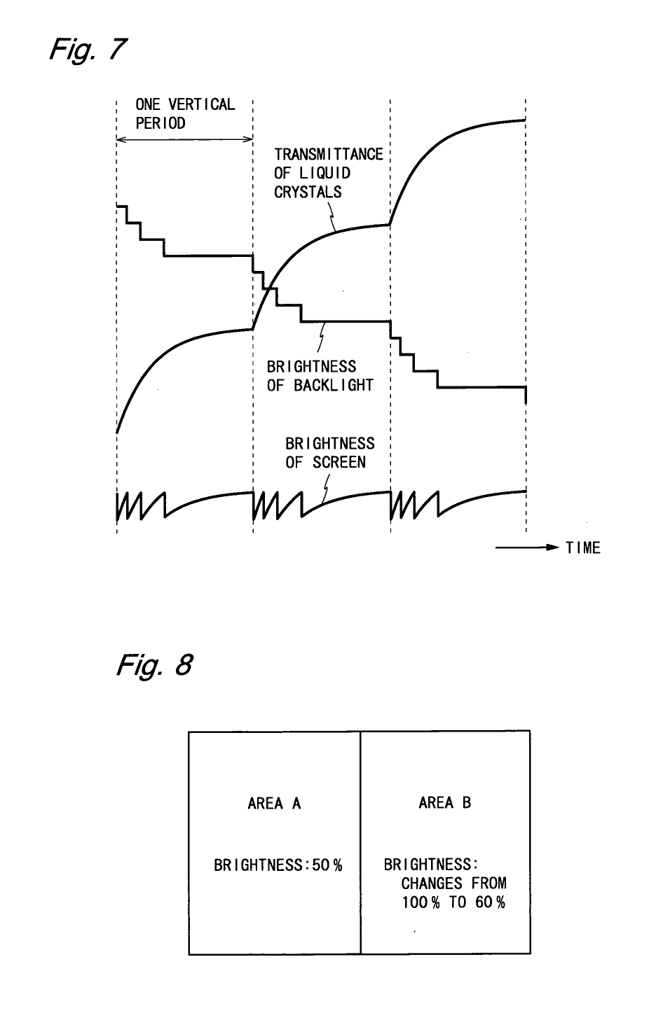

Further, according to the liquid crystal display device of the present invention, when obtaining the brightness of the backlight 12 within the first period to the M-th period, as shown in FIG. 6, it is possible to obtain brightness whose amount of change decreases in a stepwise manner from the former period to the latter period. With this, when an amount of change in the transmittance of the liquid crystals varies within a single vertical period, it is possible to effectively reduce the flickers in the screen. Moreover, a dividing number M by which a single vertical period is divided into a plurality of periods can be arbitrarily selected as long as M is equal to or greater than 2. Furthermore, when dividing a single vertical period into a plurality of periods, it is possible to divide the single vertical period into periods of different lengths. With this, when the amount of change in the transmittance of the liquid crystals varies within a single vertical period, it is possible to effectively reduce the flickers in the screen. In particular, as shown in FIG. 7, it is possible to divide the frame such that the lengths of the periods increase in a stepwise manner from the former period to the latter period. With this, when the amount of change in the transmittance of the liquid crystals is larger in the former period within a single vertical period and smaller in the latter period within the single vertical period, it is possible to effectively reduce the flickers in the screen.

Further, the liquid crystal display device 10 uses the first brightness data and the image characteristic data based on the input image data of the N-th frame for the input image data of the (N+1)-th frame. Instead, the liquid crystal display device according to the present invention may use the first brightness data and the image characteristic data based on the input image data of the N-th frame for the input image data of the N-th frame. Such a liquid crystal display device can be configured by additionally providing a buffer memory that stores image data for a single frame in the liquid crystal display device 10.

Furthermore, the present invention can be used in various image display devices provided with a backlight, other than the liquid crystal display device. Further, as one example of the active backlight technology, there is known a technology for dividing an image to be displayed into a plurality of areas, and controlling brightness of a backlight light source corresponding to each area according to characteristics of the image in each area (area active backlight technology). The present invention can be used in an image display device employing the area active backlight technology.

As described above, according to the image display device of the present invention, it is possible to reduce the flickers in the screen by changing the brightness of the backlight within a single vertical period.

### INDUSTRIAL APPLICABILITY

An image display device according to the present invention has a feature in that it is possible to reduce flickers in a screen by changing brightness of a backlight within a single vertical period, and therefore can be utilized for various image display devices that control brightness of a backlight, such as liquid crystal display devices.

### DESCRIPTION OF REFERENCE NUMERALS

10: LIQUID CRYSTAL DISPLAY DEVICE
11: LIQUID CRYSTAL PANEL
12: BACKLIGHT
13: IMAGE CHARACTERISTIC JUDGEMENT CIRCUIT
14: IMAGE DATA CONVERSION CIRCUIT
15: TIMING ADJUSTING CIRCUIT
16: FREQUENCY DIVIDING CIRCUIT
17, 19: PERIOD-BY-PERIOD BRIGHTNESS CALCULATION CIRCUIT
18: BRIGHTNESS SETTING CIRCUIT
21, 24: BRIGHTNESS CALCULATION CIRCUIT
22, 23: BRIGHTNESS CONVERSION CIRCUIT

1. An image display device that controls brightness of a backlight, the device comprising:
a display panel;
a backlight that irradiates a back surface of the display panel with light;
an image characteristic judgement portion that analyzes input image data and obtains first brightness data indicating brightness of the backlight within a single vertical period and image characteristic data corresponding to the first brightness data;
an image data converting portion that performs conversion to the input image data according to the image characteristic data and outputs the image data after the conversion to the display panel;
a period-by-period brightness calculating portion that obtains, based on the first brightness data, second brightness data indicating brightness of the backlight within each of a plurality of periods into which the single vertical period is divided; and
a brightness setting portion that controls the brightness of the backlight using the second brightness data.

2. The image display device according to claim 1, wherein
the period-by-period brightness calculating portion obtains, as the second brightness data, data indicating brightness that changes in a stepwise manner from previous brightness to current brightness within a single vertical period based on the previous brightness and the current brightness, the previous brightness being indicated by first brightness data based on input image data of a previous frame, the current brightness being indicated by first brightness data based on input image data of a current frame.

3. The image display device according to claim 2, wherein
the period-by-period brightness calculating portion obtains, as the second brightness data, data indicating brightness that has been linearly-interpolated between the previous brightness and the current brightness, based on the previous brightness and the current brightness.

4. The image display device according to claim 2, wherein
the period-by-period brightness calculating portion obtains, as the second brightness data, data indicating brightness whose amount of change decreases in a stepwise manner from a former period to a latter period, based on the previous brightness and the current brightness.

5. The image display device according to claim 2, wherein
the period-by-period brightness calculating portion divides a single vertical period into periods of different lengths and obtains the second brightness data.

6. The image display device according to claim 5, wherein
the period-by-period brightness calculating portion divides a single vertical period such that the lengths of the periods increase in a stepwise manner from a former period to a latter period.

7. The image display device according to claim 1, wherein
the period-by-period brightness calculating portion includes:
a brightness calculating portion that obtains the brightness of the backlight of each of the plurality of periods into which the single vertical period is divided, based on the brightness indicated by the first brightness data; and
a brightness conversion portion that converts the brightness obtained by the brightness calculating portion into a format outputtable to the brightness setting portion.

8. The image display device according to claim 1, wherein
the period-by-period brightness calculating portion includes:
a brightness conversion portion that converts the brightness indicated by the first brightness data into a format outputtable to the brightness setting portion; and
a brightness calculating portion that obtains the brightness of the backlight of each of the plurality of periods into which the single vertical period is divided in the format outputtable to the brightness setting portion, based on the brightness converted by the brightness conversion portion.

9. The image display device according to claim 1, wherein
the period-by-period brightness calculating portion obtains, as the second brightness data, data indicating brightness that changes in steps of a greater number than the brightness indicated by the first brightness data.

10. A method of displaying an image in an image display device including a display panel and a backlight that irradiates a back surface of the display panel with light, the method comprising:
a step of analyzing input image data and obtaining first brightness data indicating brightness of the backlight within a single vertical period and image characteristic data corresponding to the first brightness data;
a step of performing conversion to the input image data according to the image characteristic data and outputting the image data after the conversion to the display panel;
a step of obtaining, based on the first brightness data, second brightness data indicating brightness of the backlight within each of a plurality of periods into which the single vertical period is divided; and
a step of controlling the brightness of the backlight using the second brightness data.
